(19) United States
(12) Patent Application Publication
(10) Pub. No.: US 2009/0150159 A1
(43) Pub. Date: Jun. 11, 2009

(54) Voice Searching for Media Files

(75) Inventor: Eskil Gunnar Ahlin, Veberod (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/951,639

(22) Filed: Dec. 6, 2007

(51) Int. Cl. G10L 11/00

(52) U.S. Cl. 704/275

(57) ABSTRACT

A consumer electronic device has a controller, a speech processing circuit, and a memory to store media files such as audio or video files. The device allows the user to use his or her voice to fast-forward or rewind through the media file to a desired position. Particularly, the device searches one or more selected media file for an audible sound such as a keyword or phrase uttered by the user. If the device locates the audible sound, the device renders the media file having the audible sound starting from that position.

### FIELD OF THE INVENTION

The present invention relates generally to consumer electronic devices, and particularly to consumer electronic devices capable of rendering pre-recorded audio to a user.

### BACKGROUND

Portable audio and video playback devices are extremely popular with consumers. For example, many consumers own an audio player such as an iPod® or MP3 player. Indeed, the ability to render audio and/or video is so popular that many cellular telephone manufacturers now produce communication devices having audio and/or video rendering capabilities.

Most audio and video playback devices typically include controls that permit users to rewind or fast-forward through portions of the stored audio and video. This allows a user to move directly to a favorite part of a song or video while skipping over those parts deemed less important. However, such controls necessarily require the user to manually operate the controls. This makes it difficult for users to operate their audio/video devices while engaged in some activities, such as driving an automobile. Further, manual methods are not very efficient. The user typically repeats several cycles and combinations of fast-forward/play/rewind to find a desired juncture in a given file.

### SUMMARY

The present invention comprises a consumer electronic device that allows a user to fast-forward and rewind to a desired position in a media file. In one embodiment, the device has memory to store a media file, such as an audio or video file, a speech processing circuit to encode audible sounds uttered by the user, and a controller to control the speech processing circuit to search for the audible sound in the media files.

When the user utters an audible sound into a microphone of the device, the speech processing circuit encodes the audible sound to generate an encoded voice signal. The audible sound may be, for example, a keyword or phrase included in the audio content of the audio file. The speech processing circuit then searches the media file to determine whether the audible sound represented by the encoded audio signal is in the media file. By way of example, the speech processing circuit may compare the encoded voice signal to audio signals representing the audio content of a selected media file. If the speech processing circuit determines that the audible sound represented by the encoded audio signal corresponds to an audio signal in the media file, it notifies the controller. The controller then renders the media file beginning from that position.

### BRIEF DESCRIPTION OF THE DRAWINGS

FIG. 1 is a block diagram illustrating some of the component parts of a wireless communication device configured to operate according to one embodiment of the present invention.

FIG. 2 is a perspective view of a wireless communication device configured to operate according to one embodiment of the present invention.

FIG. 3 is a flow chart illustrating a method of searching for a word in a media file stored at the wireless communication device according to one embodiment of the present invention.

### DETAILED DESCRIPTION

The present invention comprises a consumer electronics device configured to locate audible sounds, such as keywords or phrases, in the audio content of a media file, such as an audio or video recording. Particularly, the device fast-forwards and rewinds through a recorded media file to search for a keyword or phrase uttered by the user. If the device locates the audible sound in the recording, the device renders the recording to the user starting from the position that the audible sound was found.

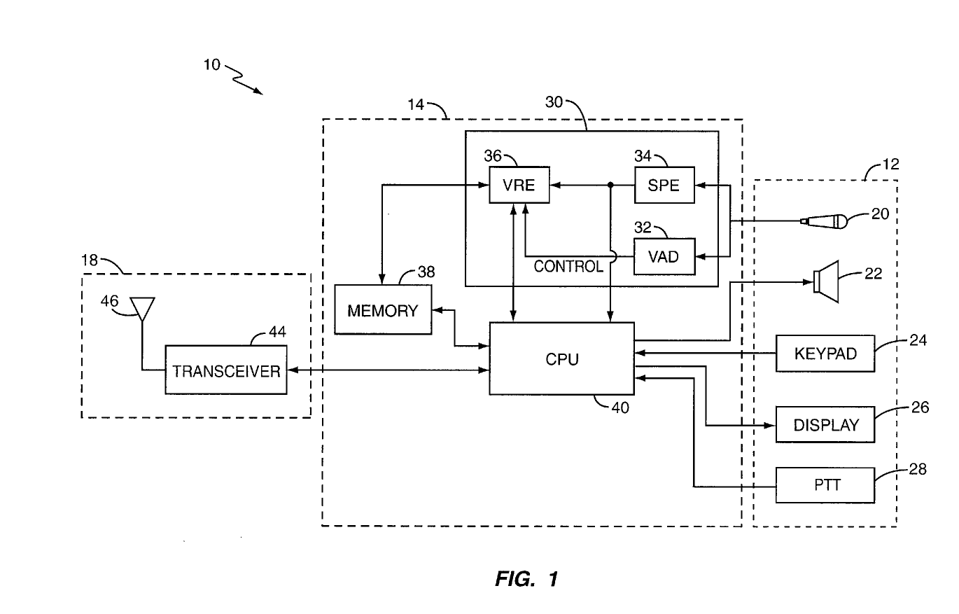

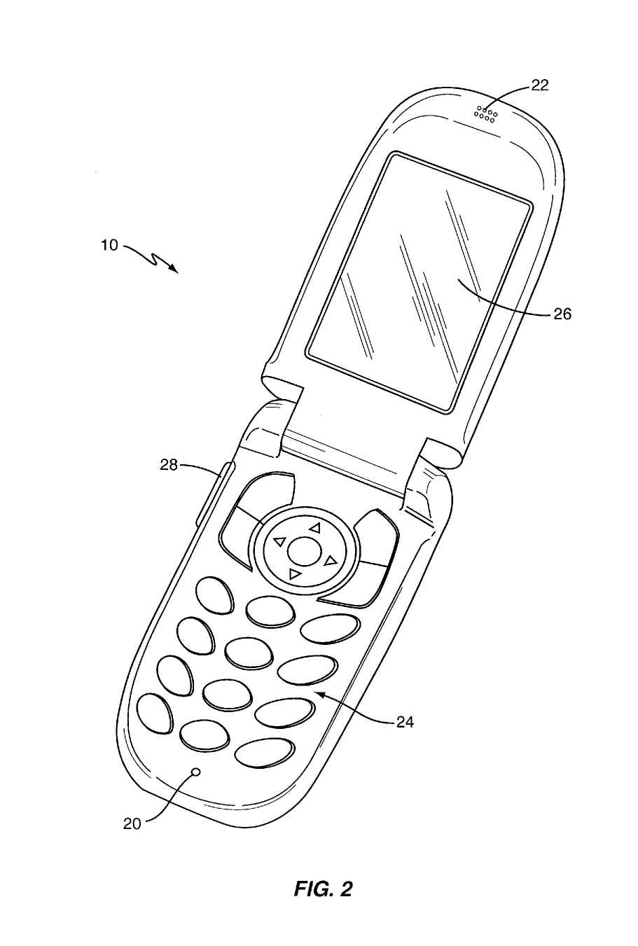

Turning now to the drawings, FIGS. 1 and 2 illustrate a consumer electronic device suitable for use with one embodiment of the present invention. As seen in these figures, the electronic device comprises a cellular telephone 10 capable of storing and rendering audio and video files. Those skilled in the art will appreciate, however, that the present invention is not limited to use in a cellular telephone. Rather, the present invention may be used with any electronic device capable of audio and/or video playback. Such devices include, but are not limited to, Personal Digital Assistants (PDAs), satellite phones, computing devices, or any suitably equipped electronic device capable of storing and rendering audio and/or video to a user.

Cellular telephone 10 comprises a user interface 12, a control circuit 14, and a transceiver section 18. User interface (UI) 12 includes microphone 20, speaker 22, keypad 24, and display 26. In some embodiments, cellular telephone 10 may have a Push-To-Talk (PTT) button 28 to allow the user to communicate with remote parties over a suitably equipped network.

Each of the UI components and their operation are well-known in the art; however, a brief description of their functions is included for completeness. Microphone 20 converts the user's speech into electrical audio signals, and passes the signals to a voice activity detector (VAD) 34 and a speech encoder (SPE) 36 of a speech processor 30. As described later in more detail, the speech processor 30 can process the user's speech to determine keywords to search for in a media file. Speaker 22 converts electrical signals into audible signals that can be heard by the user. Conversion of speech into electrical signals, and of electrical signals into audio for the user may be accomplished by any audio processing circuit known in the art. Keypad 24, which may be disposed on a front face of cellular telephone 10, includes an alphanumeric keypad and other controls, such as a joystick, button controls, or dials. Keypad 24 permits the user to dial telephone numbers, enter commands, and select menu options. Display 26 allows the operator to see the dialed digits, images, call status, menu options, and other service information. In some embodiments of the present invention, display 26 comprises a touch-sensitive screen that displays graphic images, and accepts user input.

Transceiver section 18 comprises a transceiver 44 coupled to an antenna 46. Transceiver 44 is a fully functional cellular radio transceiver that operates according to any known standard, including the standards known generally as the Global System for Mobile Communications (GSM) and Wideband Code Division Multiple Access (WCDMA). The transceiver 44 may transmit and receive signals to and from a base station in a duplex mode or a simplex mode, and may transmit and receive both voice and packet data. Therefore, the user may communicate with remote parties via a mobile communications network and/or a packet-switched network.

Control circuit 14 comprises a speech processor 30, memory 38, and a controller 40. Memory 38 represents the entire hierarchy of memory in a mobile communication device, and may include both random access memory (RAM) and read-only memory (ROM). Executable program instructions and data required for operation of cellular telephone 10 are stored in non-volatile memory, such as EPROM, EEPROM, and/or flash memory, which may be implemented as discrete or stacked devices, for example. As will be described below in more detail, memory 38 may store predetermined keywords or voice commands recognized by speech processor 30, as well as media files for rendering to the user. Such files include, but are not limited to, prerecorded audio and video files.

Controller 40 is a microprocessor that controls the operation of the cellular telephone 10 according to program instructions stored in memory 38. The control functions may be implemented in a single microprocessor, or in multiple microprocessors. Suitable microprocessors may include, for example, general purpose and special purpose microprocessors, microcontrollers, and digital signal processors. As those skilled in the art will readily appreciate, memory 38 and controller 40 may be independent components that communicate with each other, or may be incorporated into a specially designed application-specific integrated circuit (ASIC).

Speech processor 30 interfaces with controller 40 and detects and recognizes the user's speech input. Generally, any speech processor known in the art may be used with the present invention, for example, a digital signal processor (DSP). Speech processor 30 may include a voice activity detector (VAD) 32, a speech encoder (SPE) 34, and a voice recognition engine (VRE) 36. VAD 32 is a circuit that detects the presence of a voice, and outputs a signal to VRE 36 representative of voice activity on microphone 20. Thus, VAD 32 is capable of outputting a signal that is indicative of either voice activity or voice inactivity.

SPE 34 is a speech encoder that also receives an input signal from microphone 20 when a voice is present. Alternately, SPE 34 may also receive as input a signal output from VAD 32. The signal from VAD 32 may, for example, be an enable/disable signal in accordance with the voice activity/inactivity indication output by VAD 32. SPE 34 encodes the incoming speech signals from microphone 20, and outputs encoded speech to the VRE 36. The encoded speech may be output directly to VRE 36, or via controller 40 to VRE 36. Speech may be encoded according to any speech encoding standard known in the art, for example, ITU G.711 or ITU G.72x.

VRE 36 is operable in a plurality of operating modes based on control signals generated and sent by the controller 40. In a command mode, VRE 36 functions to control the operation of cellular telephone 10 based on voice commands uttered by the user. Particularly, VRE 36 compares the user's encoded speech to a plurality of predetermined voice commands stored in memory 38. VRE 36 may recognize a limited vocabulary, or may be more sophisticated as desired. If the encoded speech received by VRE 36 matches one of the predetermined voice commands, VRE 36 outputs a signal to controller 40 indicating the type of command matched. The controller 40 then performs a predetermined function based on that signal.

According to the present invention, VRE 36 is also operable in an audio search mode. In this mode, the VRE 36 searches the audio content of a media file stored in memory 38 for a keyword or phrase uttered by the user. This allows a user to fast-forward and rewind to a specific position within the file so that the audio and/or video associated with the file can be rendered starting from that position. Further, because the user can move directly to a particular position within the media file simply by speaking the content at that position, the present invention negates the need for manual controls that move forward and backward through the media file.

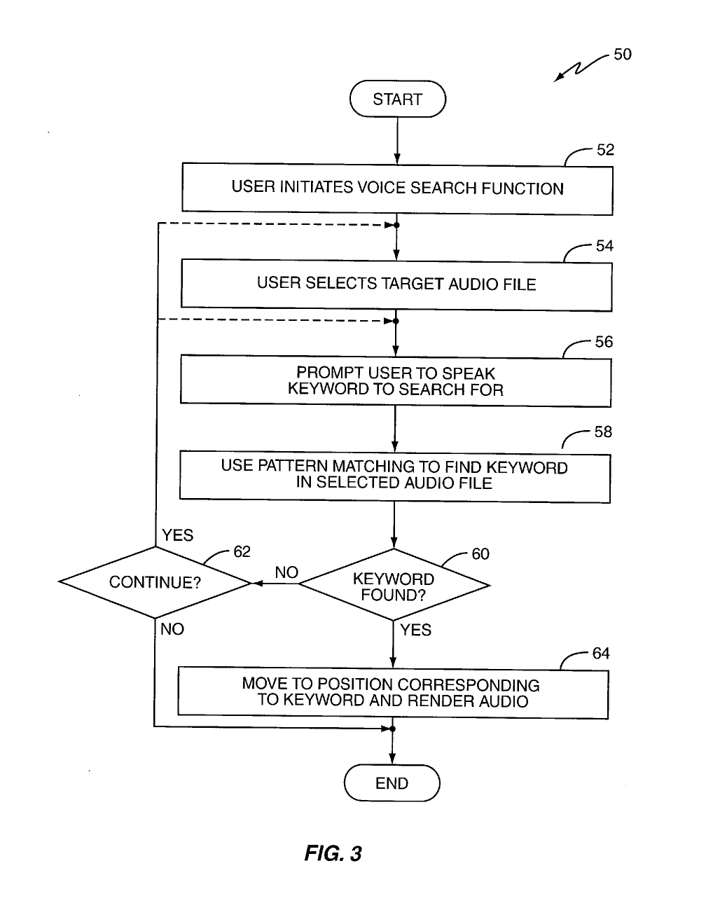

FIG. 3 is a flow diagram that illustrates a method 50 by which cellular telephone 10 searches a recorded media file for a keyword uttered by the user. FIG. 3 discusses method 50 in the context of the user searching the lyrics in an audio file that contains music. However, those skilled in the art should appreciate that this is for illustrative purposes only. The present invention may be used to search for keywords and phrases in any file that contains audio. Some examples of such media files include audio files and video files, such as audio books, music files, movies, etc.

Method 50 begins when the user places the cellular telephone 10 into the audio search mode (box 52), and selects an audio file to search (box 54). The user may perform these functions by selecting menu items from display 26 or by issuing voice commands as previously described. Once the user selects the audio file, the controller 40 prompts the user to utter the keyword to search for (box 56). Microphone 20 converts the uttered keyword into an electrical audio signal, and passes it to SPE 34 for encoding. SPE 34 then outputs the encoded keyword as an encoded voice signal to VRE 36 for comparison to one or more audio signals representing the audio content of the audio file (box 58).

If the comparison does not yield a match (box 60), the controller 40 may determine that the uttered keyword is not contained within the lyrics of the audio file. In such cases, the controller 40 may prompt the user to determine whether the user wishes to continue searching (box 62). If the user wishes to continue searching, the user may select another audio file (box 54) and/or another keyword (box 56) to search for (box 58). If, however, the comparison does yield a match (box 60), the VRE 36 sends a notification signal to controller 40 to indicate that it has found the keyword within the audio file.

The notification may include an offset that identifies the position of the keyword relative to a predetermined position in the audio file, such as the beginning of the audio file. For example, the offset may comprise a time-based offset that specifies the position of the keyword relative to the beginning of the audio file. In such cases, the offset may be in the form of seconds and/or fractional parts of seconds. Alternatively, the offset may specify the position of the located keyword relative to an end of the audio file, or to some other position in the audio file such as the current position. The controller 40 can use this information to render the audio file for the user starting from the position marked by the offset (box 64). The effect is to have moved through the audio file to a specific position as if the user had employed a fast-forward or rewind button.

The VRE 36 may search the audio file for the uttered keyword using any known searching algorithm. In one embodiment, for example, a “sliding window” algorithm is used to compare the encoded keyword signal to an audio signal that represents consecutive portions of the audio file. The present invention may search through the audio file and perform pattern matching using other known algorithms as well. It is preferred, however, that the algorithm be capable of spotting keywords or phrases on unconstrained speech to facilitate speech-independent searches. This is because most audio files will contain lyrics or words uttered by people other than the user. Therefore, any words and phrases within the audio files will likely not be separated from other words or phrases. Further, no grammar will likely be enforced on the sentences containing them. Employing search algorithms optimized for speech independence will permit users to search for, and locate, keywords spoken by other people.

It should be noted that the present invention does not require the VRE 36 to track the position of an uttered keyword. Rather, the controller 40 may increase or decrease the offset to track the position of the keyword in the media file. In such cases, the controller 40 could continue to send the audio signal to the VRE 36 automatically until it receives a signal from the VRE 36 indicating that the encoded keyword was found within the audio file. Responsive to this signal, controller 40 would generate the control signals to render the media from the offset.

The previous embodiments illustrate the present invention in terms of locating a keyword within an audio file that contains music. However, the present invention is not so limited, and may be used to search for, and locate, phrases or other sounds as well.

In addition, the present invention may be used to search for, and locate, a keyword or phrase in a video file. With video files, the controller 40 could control the VRE 36 to search an audio track for the uttered keyword or phrase. Once found, the controller 40 could forward or rewind the video to the position identified by the reported offset, and render the video and corresponding audio to the user beginning at that position.

The previous embodiments show the user selecting the audio file to search prior to uttering the keyword or phrase to search for. However, this particular sequence of steps is not required. The user may utter the keyword or phrase into microphone 20 prior to selecting the audio file. Additionally, the present invention does not limit the user to selecting only a single media file for the search. Rather, the user may select a plurality of media files for the search. In such cases, the VRE 36 could search for the keyword or phrase uttered by the user as previously described in each of the identified media files. As stated above, these files may be audio files, video files, or any combination of files having audio content.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of rendering a media file, the method comprising:
receiving an encoded voice signal that represents an audible sound uttered by a user of a consumer electronic device;
searching a selected media file stored in memory of the consumer electronic device for the audible sound represented by the encoded voice signal; and
if the audible sound is in the media file, rendering the media file to the user beginning from a position in the media file that corresponds to the audible sound.

2. The method of claim 1 wherein searching a media file for the audible sound represented by the encoded voice signal comprises comparing the encoded voice signal to one or more audio signals representing the media file content.

3. The method of claim 2 further comprising:
receiving a first audio signal representing a first portion of the audio content of the media file; and
comparing the encoded voice signal to the first audio signal to determine whether the encoded voice signal substantially matches the first audio signal.

4. The method of claim 3 further comprising receiving a second audio signal representing a second portion of the audio content of the media file, wherein the first audio signal is at least partially the same as the second audio signal.

5. The method of claim 4 wherein the first audio signal represents a portion of the media file content that occurs earlier in time than the second audio signal.

6. The method of claim 4 wherein the first audio signal represents a portion of the media file content that occurs later in time than the second audio signal.

7. The method of claim 1 further comprising:
calculating an offset to indicate the position corresponding to the audible sound found in the media file; and
sending the offset to a controller in the consumer electronic device.

8. The method of claim 7 further comprising moving forward through the media file content to the offset, and rendering the media file to the user beginning from the offset.

9. The method of claim 7 further comprising moving backward through the media file content to the offset, and rendering the media file to the user beginning from the offset.

10. The method of claim 1 wherein the audible sound uttered by the user comprises one or more words in the media file.

11. A consumer electronic device comprising:
a speech processing circuit; and
a controller configured to control the speech processing circuit to:
generate an encoded voice signal that represents an audible sound uttered by a user;
search a media file stored in a memory of the device for the audible sound represented by the encoded voice signal; and
if the audible sound is in the media file, render the media file to the user beginning at a position in the media file that corresponds to the audible sound.

12. The device of claim 11 wherein the speech processing circuit is configured to:
receive one or more audio signals representing respective portions of the media file content; and
compare the encoded voice signal to the one or more audio signals to determine if the audible sound is in the media file.

13. The device of claim 12 wherein a portion of a first audio signal is at least partially the same as a portion of a second audio signal.

14. The device of claim 13 wherein the first audio signal represents a portion of the media file content that occurs earlier in time than the second audio signal.

15. The device of claim 13 wherein the second audio signal represents a portion of the media file content that occurs earlier in time than the first audio signal.

16. The device of claim 11 wherein the controller is further configured to calculate an offset indicating a position in the media file corresponding to the audible sound.

17. The device of claim 16 wherein the controller is further configured to generate a control signal to render the media file to the user beginning from the offset.

18. The device of claim 11 wherein the media file comprises an audio file.

19. The device of claim 18 wherein the media file comprises a video file, and wherein the controller is configured to search audio associated with the video file.

20. The device of claim 11 further comprising a microphone to convert the audible sound uttered by the user to a corresponding electrical signal, and wherein the speech processing circuit comprises:
a speech recognition engine configured to generate the encoded voice signal from the electrical signal; and
a voice recognition engine configured to compare the encoded voice signal to one or more audio signals representing the media file content.

21. The device of claim 20 wherein the voice recognition engine is configured to indicate to the controller whether the audible sound is within the media file.

22. The device of claim 11 wherein the audible sound comprises a keyword included in the audio content of the media file.
